(19) United States
(12) Patent Application Publication
(10) Pub. No.: US 2026/0237021 A1
(43) Pub. Date: Aug. 13, 2026

(54) UNIFIED FRAMEWORK FOR DEEP-LEARNING BASED SUPER RESOLUTION IN COMPUTED TOMOGRAPHY CATERING TO DIFFERENT CLINICAL APPLICATIONS

(71) Applicant: GE Precision Healthcare LLC, Waukesha, WI (US)

(72) Inventors: Rajesh Langoju, Bangalore (IN); Bipul Das, Chennai (IN); Hemant Kumar Aggarwal, New Delhi (IN); Rajesh Kumar Tamada, Bangalore (IN); Brian Edward Nett, Wauwatosa, WI (US)

(21) Appl. No.: 19/050,234

(22) Filed: Feb. 11, 2025

(51) Int. Cl. G06T 3/4053; G06T 5/60

(52) U.S. Cl. CPC G06T 3/4053; G06T 5/60; G06T 2207/10081; G06T 2207/30008

(57) ABSTRACT

A unified framework for deep-learning (DL) based super resolution in computed tomography (CT) catering to different clinical applications is described. In an example, a method can comprise employing, by a system comprising a processor, a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures depicted in the medical image and a clinical application for the medical image. The method further comprises applying, by the system, a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.

### TECHNICAL FIELD

This disclosure relates generally to medical imaging, and more particularly to a unified framework for deep-learning (DL) based super resolution in computed tomography catering to different clinical applications.

### BACKGROUND

Enhancing computed tomography (CT) image resolution beyond the capabilities of current systems has been a significant area of research, with deep learning and artificial intelligence (AI) leading the charge over the past decade. While enhancing resolution generally results in sharper images, the specific requirements for resolution enhancement in CT imaging vary depending on the clinical application. For instance, the needs for lung imaging differ from those for cardiac imaging. Consequently, different training schemes and models are needed to cater to different clinical applications.

### SUMMARY

The following presents a simplified summary of the specification in order to provide a basic understanding of some aspects of the specification. This summary is not an extensive overview of the specification. It is intended to neither identify key or critical elements of the specification, nor delineate any scope of the particular implementations of the specification or any scope of the claims. Its sole purpose is to present some concepts of the specification in a simplified form as a prelude to the more detailed description that is presented later.

According to an embodiment, a system includes at least one memory that stores computer-executable components, and at least one processor that executes the computer-executable components stored in the at least one memory. The computer-executable components can comprise a resolution enhancement component and a spectral shaping component. The resolution enhancement component employs a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures and a clinical application for the medical image. The spectral shaping component applies a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.

In some implementations, the one or more modified properties comprise a change to frequency content of the first enhanced medical image within the increased bandwidth, wherein the change is tailored to the anatomical structures and the clinical application. Additionally, or alternatively, the one or more modified properties comprise a change to the increased bandwidth, wherein the change is tailored to the anatomical structures and the clinical application.

In some implementations, based on the anatomical structures comprising a first type of anatomical structures and the clinical application comprising a first clinical application, the one or more modified properties comprise a first change to frequency content of the first enhanced medical image, and wherein based on the anatomical structures comprising a second type of anatomical structures and the clinical application comprising a second clinical application different from the first clinical application, the one or more modified properties comprise a second change to frequency content of the first enhanced medical image different from the first change.

In various embodiments, the resolution enhancement model transforms the medical image into the first enhanced medical image in accordance with a first kernel tailored to a first type of anatomical structures and a first clinical application, and wherein the spectral shaping filter corresponds to a second kernel different from the first kernel. In some implementations of these embodiments, based on the anatomical structures and the clinical application corresponding to the first type and the first clinical application respectively, the second kernel corresponds to a modified version of the first kernel. In other implementations, based on the anatomical structures and the clinical application corresponding to a second type and a second clinical application different from the first clinical application, the second kernel is tailored to the second type and the second clinical application. Still in other implementations, based on the anatomical structures and the clinical application corresponding to a second type and a second clinical application different from the first clinical application, the second kernel corresponds to a modified version of the first kernel with a third kernel tailored to the second type and the second clinical application.

In one or more embodiments, the resolution enhancement model comprises a neural network model, and wherein the computer-executable components further comprise a training component that trains the neural network model on training images corresponding to a first clinical application and using a supervised machine learning process with ground truth targets corresponding to medical image versions of natural images reconstructed in accordance with a target kernel for the first clinical application. In some implementations of these embodiments, the anatomical structures and the clinical application comprise a second type and a second clinical application different from the first clinical application, and wherein the medical image comprises an image reconstructed in accordance with a different kernel relative to the target kernel, the different kernel being tailored to the second type and the second clinical application. In some implementations, the first clinical application comprises a bone imaging application and wherein the target kernel comprises a sharp kernel.

In various embodiments, the medical image comprises a computed tomography (CT) image. In other embodiments, the medical image can comprise an X-ray image, a magnetic resonance image, an ultrasound image, or another type of medical imaging modality image.

In some embodiments, elements described in connection with the disclosed systems can be embodied in different forms such as a computer-implemented method, a computer program product, or another form.

For example, in another embodiment, a computer-implemented method, can comprise employing, by a system comprising a processor, a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures and a clinical application for the medical image. The method further comprises applying, by the system, a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.

In another embodiment, a non-transitory machine-readable storage medium can comprise executable instructions that, when executed by a processor, facilitate performance of operations, comprising: employing a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures and a clinical application for the medical image, and applying a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a high-level block diagram of an example system that facilitates a unified framework for deep-learning based super resolution in medical imaging catering to different clinical applications, in accordance with one or more embodiments described herein;

FIG. 2A shows a CT scanner according to an embodiment.

FIG. 2B shows a block diagram for a CT hardware and software system, according to an embodiment.

FIG. 3 illustrates a flow diagram of an example process for enhancing medical images in accordance with one or more embodiments described herein;

FIG. 4 illustrates example versions of a CT images in accordance with one or more embodiments described herein;

FIGS. 5A and 5B respectively present different examples of input and output CT images of a trained version of a resolution enhancement model, in accordance with one or more embodiments.

FIG. 6A presents a graph comparing the modulation transfer functions (MTFs) of different target kernels in accordance with one or more embodiments described herein;

FIG. 6B presents a graph illustrating a harmonizing spectral filter, in accordance with one or more embodiments described herein;

FIG. 7 illustrates example versions of a CT images in accordance with one or more embodiments described herein;

FIG. 8 illustrates an example computer-implemented method for enhancing medical images, in accordance with one or more embodiments described herein;

FIG. 9 illustrates another example computer-implemented method for enhancing medical images, in accordance with one or more embodiments described herein;

FIG. 10 is a schematic block diagram illustrating a suitable operating environment; and

FIG. 11 is a schematic block diagram of a sample-computing environment.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

As described in the Background Section, while enhancing CT image resolution beyond the native capabilities of the imaging system using AI techniques generally results in sharper images, the specific requirements for resolution enhancement in CT imaging vary depending on the clinical application. For instance, the needs for lung imaging differ from those for cardiac imaging. The same concept also applies to other imaging modalities, such as X-ray, MRI, ultrasound, and others.

Critical factors in a super resolution for CT images are: (a) display field of view (DFOV); (b) frequency characteristics of the input and target kernels; (c) amplitude, and distribution characteristics of noise; and (d) artifacts that occur due to acquisition and reconstruction physics. While the DFOV is decided by the portion of anatomy to be displayed (e.g., the anatomical region of interest (ROI)), the kernel is chosen based on the type(s) of the anatomical structure(s) of interest included in the ROI and the clinical application for the images. As used herein, reference to the “clinical application” (also referred to as the “clinical indication”) for a medical image refers to the purpose or use of the medical image, such as assessing or detecting bone fractures, assessing or detecting lung nodules, assessing or detecting tumors, monitoring disease progression, etc. In this regard, the clinical application for a medical image involves the ways the image is intended to be used to aid in diagnosis, treatment planning, monitoring, or guiding interventions. Different medical imaging modalities (e.g., X-ray, CT, MRI, ultrasound) have different clinical applications based on the type of information they provide and their abilities to visualize certain tissues or pathologies. Within the same imaging modality, different kernels are tailored for different for different types of anatomical structures and clinical applications for the images.

The DFOV affects pixel resolution (along with finite system bandwidth) for each clinical application. However, training AI models for different DFOVs, anatomical structures of interest, and clinical applications is a tedious and expensive process. Additionally, in a supervised framework, the training process requires training data pairs (low-resolution and high-resolution images) corresponding to each of the configuration characteristics. Similarly, each kernel has different frequency characteristics and noise behavior. Thus, developing medical image enhancement models that account for these wide range of variables (e.g., DFOV, resolution, noise and kernel shape) for different clinical applications and anatomical structures is quite complex, often leading to multiple models and sub-optimal solutions. Consequently, different training schemes and models are needed to cater to different clinical applications.

With this context in mind, the disclosed subject matter is directed to systems, computer-implemented methods, apparatus and/or computer program products that provide a unified framework for deep-learning (DL) based super resolution in CT catering to different clinical applications. In various embodiments, the same framework can also be extended to other imaging modalities, such as X-ray, MRI, ultrasound and others. The framework combines physics, signal processing, and deep learning such that a single resolution enhancement model can be trained and employed for different types of anatomical structures and clinical applications. In various embodiments, different clinical applications can include but are not limited to, a bone CT imaging application, a lung CT imaging application, a cardiac CT imaging application, a neuro CT imaging application, and the like. The framework is divided into two parts.

The first part includes a common resolution enhancement model (a DL model) trained to improve the resolution of the input medical images by expanding their bandwidth, making them appear sharper. The resolution enhancement model is configured to enhance the bandwidth or spatial resolution of the input medical images regardless of the anatomical region or structure(s) depicted in the input images and the clinical application for the medical images. In other words, the resolution enhancement model is anatomical structure and clinical application agnostic (e.g., applicable to increasing the resolution of medical images regardless of the type or types of anatomical structures of interest depicted and the clinical application for the medical images).

The second part includes a spectral shaping process which shapes the output of the resolution enhancement model using a spectral shaping filter tailored to meet specific requirements for optimizing image quality based on the type of anatomical structures depicted and clinical applications of the images. For example, for bone imaging, the spectral shaping filter can be configured to modify the spectrum while maintaining the bandwidth so that fine bone structures (e.g., inner ear structures, paranasal sinuses, extremities, etc.) can be seen clearly. For lung imaging, the spectral shaping filter can be configured to enhance contrast in the lung parenchyma, tuning the bandwidth or spatial resolution to the requirements. For cardiac imaging, the spectral shaping filter can be configured to ensure noise is well controlled while maintaining sufficient resolution to visualize plaques, stents, and smaller vessels.

The spectral shaping process provides the flexibility to design any spectral filter with desired characteristics and the resolution enhancement model output can be adjusted to suit the application requirements. This approach streamlines the AI based medical image resolution enhancement process, making it more efficient to meet the diverse needs of various clinical applications without retraining models for each of these applications.

The terms “algorithm” and “model” are used herein interchangeably unless context warrants particular distinction amongst the terms. The terms “artificial intelligence (AI) model” and “machine learning (ML) model” are used herein interchangeably unless context warrants particular distinction amongst the terms. Reference to an AI or ML model herein can include any type of AI or ML model, including (but not limited to): deep learning (DL) models, neural network models, deep neural network models (DNNs), convolutional neural network models (CNNs), generative adversarial neural network models (GANs), transformer models, and the like. An AI or ML model can include supervised learning models, unsupervised learning models, semi-supervised learning models, combinations thereof, and models employing other types of ML learning techniques. An AI or ML model can include a single model or a group of two or more models (e.g., an ensemble model, chained models, or the like).

Although various embodiments are described in association with enhancing CT images, the disclosed techniques can also be applied to medical images of other medical imaging modalities. For example, the other medical imaging modalities can include, but are not limited to, X-ray, digital radiography (DX) X-ray, X-ray angiography (XA), panoramic X-ray (PX), mammography (MG), (including tomosynthesis devices), magnetic resonance imaging (MRI), ultrasound (US), color flow doppler (CD) devices, position emission tomography (PET), single-photon emissions computed tomography (SPECT), nuclear medicine (NM), and the like.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

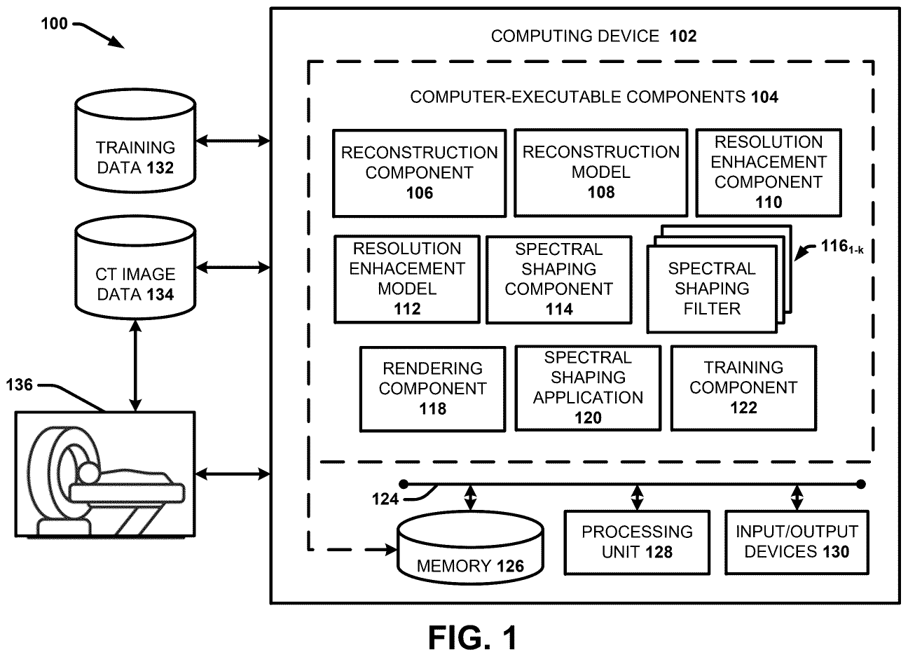

Turning now to the drawings, FIG. 1 illustrates a high-level block diagram of an example system 100 that facilitates a unified framework for DL based super resolution in medical imaging catering to different clinical applications, in accordance with one or more embodiments. System 100 can include or correspond to one or more computing devices, machines, virtual machines, computer-executable components, datastores, and the like that may communicatively coupled to one another either directly or via one or more wired or wireless communication frameworks. For example, system 100 can include computing device 102, a datastore comprising training data 132, a datastore comprising CT image data 134 and a CT scanner 136. These elements can be respectively connected to one another via any suitable wired or wireless communication framework.

Aspects of the systems, apparatuses or processes explained in this disclosure can constitute computer-executable or machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

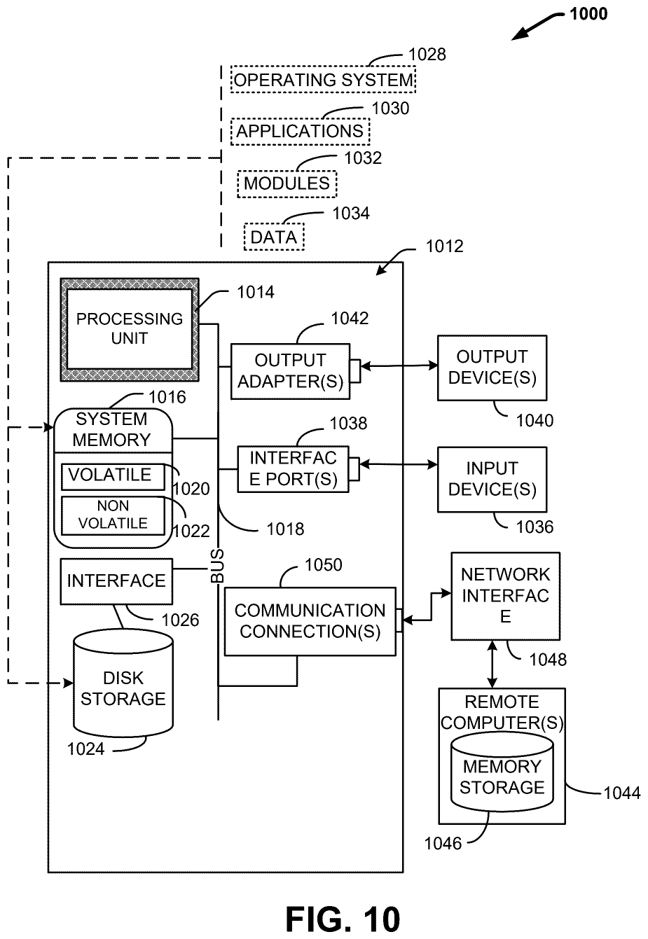

For example, computing device 102 can comprise at least one memory 126 that stores computer-executable components 104, and at least one processor or processing unit 128 that executes the computer-executable components 104 stored in the at least one memory 126. The computer-executable components 104 include, but are not limited to, reconstruction component 106, reconstruction model 108, resolution enhancement component 110, resolution enhancement model 112, spectral shaping component 114, one or more spectral shaping filters 116₁₋ₖ (wherein the number of filters k can include any integer), rendering component 118, spectral shaping application 120 and training component 122. Examples of said memory 126 and processing unit 128 as well as other suitable computer or computing-based elements, can be found with reference to FIG. 10 (e.g., system memory 1016 and processing unit 1014 respectively), and can be used in connection with implementing one or more the components shown and described in connection with FIG. 1, or other figures disclosed herein.

Computing device 102 can further include one or more input/output devices 136 to facilitate receiving user input and rendering data (e.g., medical images, graphical user interfaces of the spectral shaping application 120, etc.) to users in association with performing various operations described with respect to the order computer-executable component 104. Suitable examples of the input/output devices 126 are described with reference to FIG. 10 (e.g., input devices 1036 and output devices 1040). Computing device 102 can further include a system bus 124 that couples the memory 126, the processing unit 128 and the input/output devices 130 to one another.

In various embodiments, computing device 102 can include or correspond to a computing device coupled to medical imaging system 136 that performs image reconstruction (e.g., via reconstruction component 106) to generate medical images based on raw signal data acquired via the medical imaging system 136. Additionally, or alternatively, computing device 102 can include or correspond to a computing device that can perform post-processing enhancement of medical images generated via any medical imaging system (e.g., via resolution enhancement component 110, resolution enhancement model 112, spectral shaping component 114 and spectral shaping filters 116₁₋ₖ). In some embodiments, the medical imaging system 136 includes or corresponds to a CT scanner. In other embodiments, the medical imaging system 136 can include or correspond to medical imaging system of another type of modality, such as an MRI scanner, an X-ray imaging system, an ultrasound imaging system, a nuclear medicine imaging system, or another type of medical imaging system.

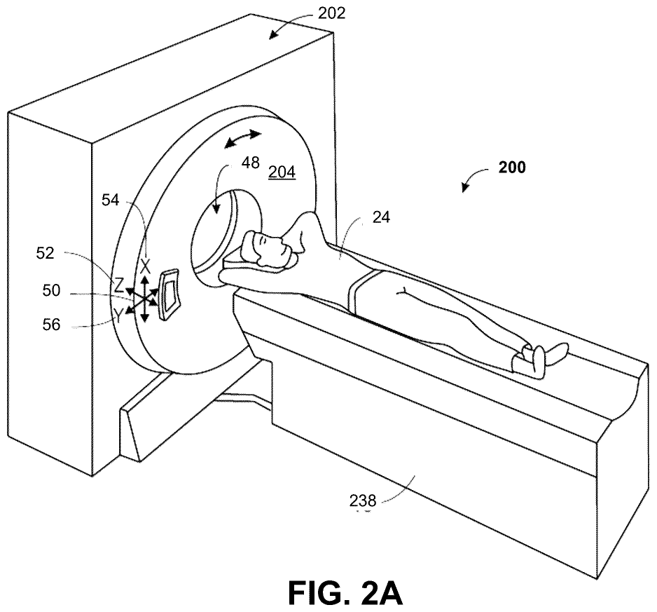

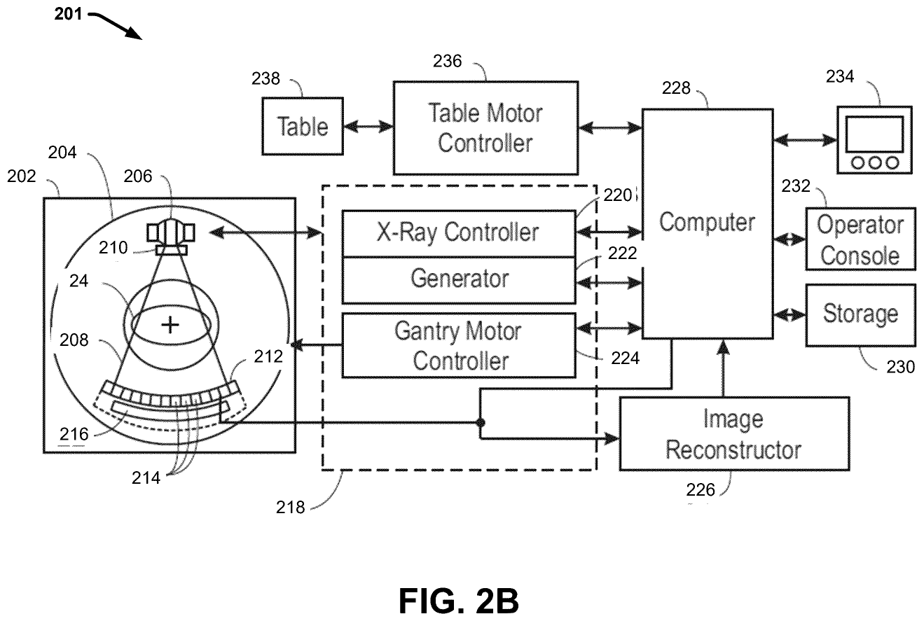

FIG. 2A shows a CT scanner 200 according to an embodiment. FIG. 2B shows a block diagram for a CT hardware and software system 201 incorporating CT scanner 200, according to an embodiment. With reference to FIGS. 1, 2A and 2B, in some embodiments, CT scanner 132 can include or correspond to CT scanner 200.

As shown in FIGS. 2A and 2B, CT scanner 200 includes a gantry 202 having a rotary member 204 and an x-ray source 206 that projects a beam of x-rays 208 through a pre-patient collimator 210 toward a detector assembly 212 on the opposite side of the rotary member 204. The X-ray source 206 may also be referred to as x-ray tube or x-ray generation component. The X-ray source 206 is a type of emissions component. A main bearing may be utilized to attach the rotary member 204 to the stationary structure of the gantry 202. The detector assembly 212 is formed by a plurality of detectors 214 and data acquisition systems (DAS) 216 and can include a post-patient collimator. The plurality of detectors 214 sense the projected x-rays that pass through a subject 24, and DAS 216 converts the data to digital signals for subsequent processing. Each detector 214 produces an analog or digital electrical signal that represents the intensity of an impinging x-ray beam and hence the attenuated beam as it passes through the subject 24. During a scan to acquire x-ray projection data, rotary member 204 and the components mounted thereon can rotate about a center of rotation.

Rotation of rotary member 204 and the operation of x-ray source 206 are governed by a control mechanism 218 of the CT scanner 200. Control mechanism 218 can include an x-ray controller 220 and generator 222 that provides power and timing signals to the X-ray source 210 and a gantry motor controller 224 that controls the rotational speed and position of rotary member 204. Image reconstructor 226 receives sampled and digitized X-ray data from DAS 216 and performs high speed image reconstruction to generate a CT image. The reconstructed CT image is output to a computer 228 which stores the image in a computer storage device 230.

Computer 228 also receives commands and scanning parameters from an operator via operator console 232 that has some form of operator interface, such as a keyboard, mouse, touch sensitive controller, voice activated controller, or any other suitable input apparatus. Display 234 allows the operator to observe the reconstructed image and other data from computer 228. The operator supplied commands and acquisition parameters are used by computer 228 to provide control signals and information to DAS 216, X-ray controller 220, and gantry motor controller 224. In addition, computer 228 operates a table motor controller 236 which controls a motorized table 238 to position subject 24 and gantry 202. Particularly, table 238 moves a subject 24 through a gantry opening 48, or bore, in whole or in part. A coordinate system 50 defines a patient or Z-axis 52 along which subject 24 is moved in and out of opening 48, a gantry circumferential or X-axis 54 along which detector assembly 212 passes, and a Y-axis 56 that passes along a direction from a focal spot of x-ray source 206 to detector assembly 212.

In some embodiments, computing device 102 can include or correspond to computer 228. Additionally, or alternatively, image reconstructor 226 can include or correspond to reconstruction component 106 executed by computing device 102 or computer 228. Thus, in some embodiments, reconstruction component 106 can perform CT image reconstruction of raw signal data collected by CT scanner 132 (or CT scanner 200) to generate CT images corresponding to 2D cross-sectional slices of the scanned anatomical region of interest (ROI).

Medical image reconstruction is the process of transforming raw signal data collected by a medical imaging system 136, scanner such as CT scanner 200, into a cross-sectional image. This involves mathematical algorithms and computational techniques which vary depending on modality. For example, as applied to CT and X-ray, the raw signal data is referred to as projection data. During a CT imaging scan and an X-ray scan, X-rays 208 pass through the subject 24 (e.g., the human body) and are detected by the detector assembly 212 after attenuation. Detectors 214 measure the intensity of transmitted X-rays, creating projection data from multiple angles around the anatomical region of the subject scanned. These projections are organized into a two-dimensional (2D) plot called a sinogram, representing the raw data.

Several methods exist for CT image reconstruction, including filtered back projection (FBP), iterative reconstruction (IR), algebraic reconstruction techniques (ART), model-based iterative reconstruction (MBIR), and deep-learning (DL) based reconstruction methods. In FBP, for each angle, the projection data is back projected across the image domain along the direction of the X-ray beam. To address blurring, a mathematical filter (e.g., Ram-Lak filter) is applied to enhance edges and preserve details. In IR, the reconstruction algorithm starts with an initial guess of the image. It then compares simulated projections from the guess with measured projections and adjusts the guess iteratively to minimize differences. Algebraic reconstruction techniques (ART) treat reconstruction as a system of linear equations and solves them iteratively by updating the image based on discrepancies between measured and calculated projections.

MBIR methods incorporate physical and statistical models of the CT scanner and noise to perform image reconstruction. More particularly, MBIR methods explicitly account for imaging system statistics, X-ray physics, system optics, and patient characteristics all at the same time. To make the solution tractable (i.e. capable of being handled mathematically), the traditional ways of handling these models focus on simplifying complex and often intertwined phenomena with our theoretical understanding of the physics, statistics, image properties, and engineering. This approach manages the optimization of the IR solution with a limited number of parameters, typically less than a hundred, either calculated or manually tuned.

Deep learning (DL) models have become increasingly integral to CT image reconstruction, offering significant advantages in terms of speed, accuracy, and image quality. Deep learning (DL) is a subset of machine learning (ML), both of which are subsets of artificial intelligence (AI). AI is a broad term to cover the theory and development of computer systems to be able to perform tasks that normally require human intelligence. ML is based on the idea that systems can learn from data, patterns, and features to make decisions with minimal human intervention; and DL utilizes Deep Neural Networks (DNNs) to accomplish the same tasks that ML does. A DNN consists of multiple layers of mathematical equations, and it can find the correct mathematical manipulation to turn the input into the output, whether it be a linear or non-linear relationship.

A DL-CT reconstruction model leverages machine learning and deep learning techniques to address challenges in traditional and MBIR reconstruction methods. A DL-CT reconstruction model performs data-to-image reconstruction, wherein the model learns to map raw projection data (sinogram data) directly to reconstructed images. In some embodiments, reconstruction model 108 corresponds to a DL-CT reconstruction model and the reconstruction component 106 can generate CT images from corresponding projection data captured via CT scanner 136 using reconstruction model 108. In this regard, DL-CT reconstruction methods involve training a neural network model (e.g., a DNN) to generate a desired output CT image having desired properties, wherein the input can comprise the raw projection data. For example, a DL-CT image reconstruction model builds upon specific knowledge of the detailed design of the particular CT system. This includes knowledge of the conditioning of the collected data. Even more importantly, this knowledge is embedded within a DNN, which is capable of learning through a large number of real-world examples. Through these examples, the DL-CT image reconstruction model gradually optimizes the coefficients of its internal network as it figures out how to arrive at the optimal solution (i.e. the best image). Like in the human learning process, both the training data and the training process are important to the success of the DL-CT image reconstruction model.

AI-based CT imaging techniques also include image-to-image enhancement models, which refine the output of traditional reconstruction techniques like FBP and MBIR.

Image reconstruction in MRI refers to the process of converting the raw data acquired during an MRI scan (called k-space data). During an MRI scan, the body is exposed to a strong magnetic field and radiofrequency (RF) pulses. Hydrogen nuclei in tissues resonate and emit RF signals, which are detected by receiver coils. These signals are recorded in the frequency domain, called k-space. K-space is a grid where each point corresponds to a spatial frequency component of the final image. The MRI system fills k-space line by line or in more complex patterns depending on the imaging sequence and scanning protocol. Image reconstruction primarily involves applying the inverse Fourier transform (IFT) to k-space data. This transforms the frequency-domain data into spatial domain information, resulting in an image. Additional processing may be applied to correct artifacts or distortions caused by system imperfections, motion, or magnetic field inhomogeneities. Enhancements like smoothing, sharpening, or edge detection may be applied to optimize the image for specific diagnostic tasks.

In accordance with various embodiments, computer-executable component 104 can employ a combination of an AI model-based medical image enhancement process combined with a spectral shaping process to generate high quality super-resolution medical images that have a higher resolution than the native capabilities afforded by the imaging system 136 used to acquire the medical images (e.g., a CT scanner 200 and/or system 201, an MRI scanner, or another type of imaging modality scanner) and the reconstruction method used to generate the medical images. Same or similar techniques can be used to enhance medical images from varying modalities, including CT, MRI, X-ray, ultrasound and others.

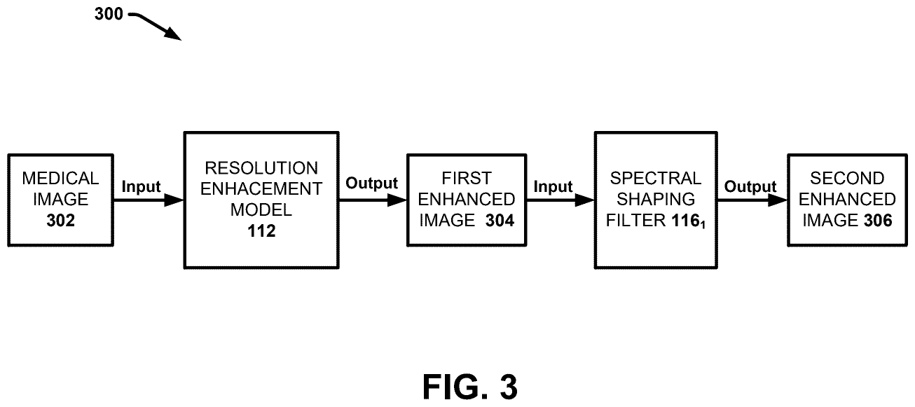

FIG. 3 illustrates a flow diagram of an example process 300 for enhancing medical images in accordance with one or more embodiments described herein. With reference to FIGS. 1-3, process 300 corresponds to a high-level process that can be performed by computing device 102 in accordance with the disclosed techniques using resolution enhancement component 110, resolution enhancement model 112, spectral shaping component 114 and one or more spectral shaping filters 116₁₋ₖ.

In accordance with process 300, the enhancement component 108 first employs resolution enhancement model 112 to process a medical image 302 as input and generates a first enhanced version of the medical image as output (e.g., first enhanced medical image 304), the first enhanced image 304 having an increased bandwidth (and thus resolution) relative to the input medical image 302. As described in greater detail below, the resolution enhancement model 112 is configured to generate the first enhanced image 304 regardless of anatomical structures depicted in the medical image and a clinical application for the medical image. In some embodiments, the first enhanced image 304 can also have a reduced amount or intensity of artifacts and/or controlled noise characteristics relative to the medical image 302 as a result of processing by the resolution enhancement model 112. In this regard, generally, increasing the bandwidth and thus resolution of a medical image can result increasing noise and artifacts. It is very important to note that the resolution enhancement model 112 is configured (i.e., trained) to control both noise and artifacts while improving the resolution.

In some embodiments, the medical image 302 comprises a CT image. In other embodiments, the medical image 302 comprises an MRI image. Still, in other embodiments, the medical image 302 can comprise an ultrasound image, an X-ray image, a nuclear medicine image, or another type of medical imaging modality image. In embodiments in which the input medical image 302 comprises a CT image, the CT image can include or correspond to a CT image reconstructed from raw projection data using FBP or any other reconstruction method, such as IR, MBIR, a CT-DL reconstruction model, or another reconstruction method. For example, in some implementations, the reconstruction component 106 can generate the input CT images using reconstruction model 108, which can correspond to a CT-DL reconstruction model. In other embodiments, the input CT image 302 can correspond to a previously reconstructed image that was reconstructed by another system (e.g., system 201 and image reconstructor 226, or another CT imaging system) using any reconstruction method and stored in an accessible datastore (e.g., included in CT image 130, storage 230, or the like).

The spectral shaping component 114 then applies a spectral shaping filter 116₁ (selected from amongst spectral shaping filters 116₁₋ₖ) to the first enhanced image 304 to transform the first enhanced CT image 304 into a second enhanced image 306 having one or more modified properties relative to the first enhanced medical image 302. As described in greater detail below, in some implementations, the one or more modified properties of the second enhanced medical image 306 can include a change to the frequency content of the first enhanced image 304 within the increased bandwidth, wherein the change is tailored to the anatomical region or structures depicted in the medical image 302 and the clinical application for the medical image 302. Additionally, or alternatively, the one or more modified properties can include a change (i.e., an increase or decrease) to the increased bandwidth of the first enhanced image 304, wherein the change is tailored to the anatomical structures represented in the medical image 302 and the clinical application for the medical image 302. These modified properties of the second enhanced medical image 306 in the spatial frequency domain result in changing the visual appearance properties of the second enhanced image 306 relative to the first enhanced image 304 with respect to noise, contrast and resolution.

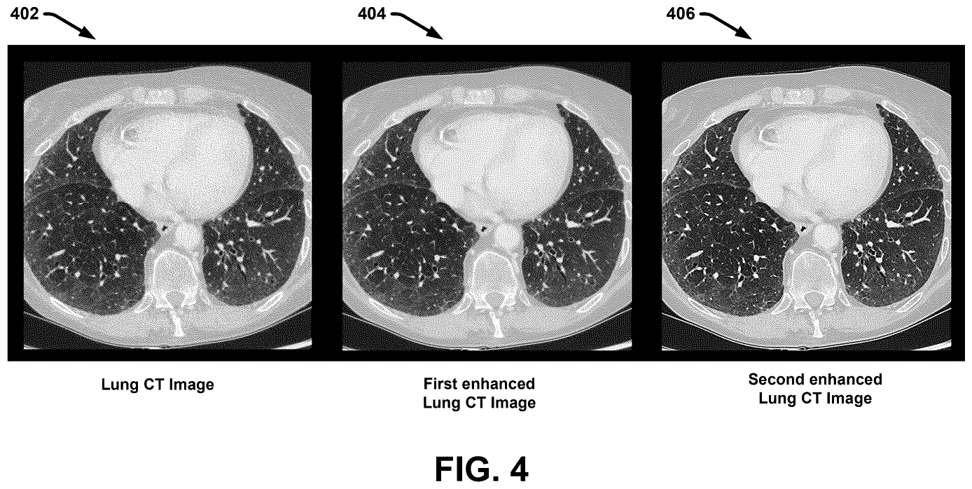

For example, FIG. 4 illustrates example versions of a CT images throughout process 300, in accordance with one or more embodiments described herein. In this regard, lung CT image 402 corresponds to medical image 302, that is the image that is input to the resolution enhancement model 112. First enhanced lung CT image 404 corresponds to first enhanced image 304, that is the image that is output by the resolution enhancement model 112. Second enhanced lung CT image 406 corresponds to second enhanced image 306, that is the image that results after application of a spectral filter (e.g., spectral shaping filter 116₁ for example) tailored to a lung imaging application in CT. As can be seen by comparison of lung CT image 402 to first enhanced lung CT image 404, the resolution enhancement model 112 increases the resolution and thus sharpness of the structures in the lungs. As can be seen by comparison of first enhanced lung CT image 404 to second lung enhanced CT image 406, the spectral shaping filter further significantly enhances contrast in the lung parenchyma.

With reference back to FIGS. 1-3, in various embodiments, the resolution enhancement model 112 comprises a neural network model (e.g., a DNN model such as a convolutional neural network model (CNN) or the like) that has been trained to transform input medical images (e.g., medical image 302) of a specific modality (e.g., CT, MR, X-ray, etc.) into resolution enhanced versions thereof (e.g., first enhanced medial image 304) regardless of the type(s) of anatomical structure(s) depicted in the medical image 302 (e.g., bones, specific bones, specific types of organs, specific types of tissues, etc.) and the clinical applications for the medical images (e.g., assessing/detecting bone fractures, assessing/detecting nodules, assessing/detecting tumors, etc.). In other words, the resolution enhancement model 112 can be applied to medical images of the same modality on which the model is trained, yet wherein the medical images may depict different anatomical ROIs, different anatomical structures and/or be associated with different clinical applications. For example, medical image 302 may correspond to a bone CT image, a lung CT image, a cardiac CT image, a brain CT image, and so on. In other embodiments, the resolution enhancement model 112 can be applied to medical images of the same modality on which the model is trained, yet wherein the medical images may depict different anatomical ROIs, different anatomical structures and/or be associated with different clinical applications, so long as the DFOV is withing the bounds of the DFOV of the training medical images used to train the resolution enhancement model 112. In some embodiments, the training component 120 can train the resolution enhancement model 110 using training data 128, as described in greater detail below.

However, the particular spectral shaping filter applied (e.g., spectral shaping filter 116₁ for example) by the spectral shaping component 114 to the first enhanced medical image 304 is tailored to the type or types of anatomical structures represented in the medical image 302 (and/or the first enhanced image 304) and the clinical application for the medical image. In particular, the changes to the visual appearance properties created in the second enhanced image 306 as a result of the applied spectral filter are tailored based on the anatomical region or structures depicted and the corresponding clinical application. For example, for bone imaging, the spectral shaping filter can be configured to modify the spectrum at certain frequency regions while maintaining the bandwidth, so that fine bone structures (e.g., inner ear structures, paranasal sinuses, extremities, etc.) can be seen clearly. For example, in lung imaging, the spectral shaping filter can be configured to boost the mid-frequency region of the resolution enhancement model output to enhance contrast in the lung parenchyma, tuning the bandwidth to the requirements. For cardiac imaging, the spectral shaping filter can be configured to ensure noise is well controlled while maintaining sufficient resolution to visualize plaques, stents, and smaller vessels.

In this regard, the resolution enhancement model 112 is configured to increase the bandwidth or spatial resolution of the input medical image 302 beyond that capable of being achieved by the imaging system (e.g., imaging system 136 or another imaging system) used to acquire the medical image 302 and/or using existing image reconstruction techniques available for the corresponding imaging modality. As applied to CT images, critical parameters evaluated by the resolution enhancement model 112 to create the first enhanced image 304 are: (a) display field of view (DFOV); (b) frequency characteristics of the kernel used to generate the medical image 302 and the target kernel for the first enhanced image 304; (c) noise amplitude and distribution parameters; and (d) artifacts that occur due to acquisition and reconstruction physics.

In CT image reconstruction as well as X-ray image reconstruction, a kernel is a mathematical function or filter used during the image reconstruction process to enhance specific features of the image, such as edges, contrast, or smoothness. Kernels play a crucial role in shaping the final reconstructed image's appearance and diagnostic utility. In FBP, the kernel is part of the filtering step applied to projection data before back-projection. The filtering corrects for the blurring introduced by simple back-projection and enhances specific details. More particularly, in FBP, the raw projection data contains contributions from all X-ray paths through the scanned ROI. Without filtering, the back-projection smears these contributions, leading to blurred images. A kernel modifies the frequency content of the data. For example, in some implementations, the kernel filter can enhance high frequencies to emphasize sharp edges or suppress low frequencies to reduce noise.

In MRI imaging, kernels are applied to the reconstructed image or k-space data to enhance image quality by suppressing noise or improving contrast. They are mathematical tools or matrices applied to the data in various stages of the reconstruction process to filter, interpolate, or enhance specific features. In ultrasound imaging, kernels are used to process and enhance the raw ultrasound signals or images to improve diagnostic quality. These kernels are mathematical filters or convolution matrices applied during various stages of image processing to perform tasks such as noise reduction, edge enhancement, feature extraction, and artifact suppression. Ultrasound imaging relies heavily on real-time processing, so the kernels must be efficient while maintaining image clarity. In nuclear medicine (e.g., PET/SPECT), kernels are used to reconstruct images from gamma-ray emissions, often with low signal-to-noise ratio (SNR). In mammography, kernels are used to detect microcalcifications and masses in breast tissue with high contrast and resolution/

In this regard, kernels are used to modify the frequency content of medical images in many modalities. Kernels differ across various medical imaging modalities due to the unique physical principles, data acquisition methods, and clinical requirements of each modality. For respective modalities, different kernels are designed for specific clinical or diagnostic needs, balancing noise and detail. Common types include sharp kernels which emphasize high-frequency components to enhance edges and fine details. For example, in CT, sharp kernels are typically used for bone imaging or high-resolution applications. However, sharp kernels have the drawback of increased noise. Smooth kernels reduce high-frequency components, leading to smoother images with reduced noise. Smooth kernels are typically used for soft tissue imaging or low-noise requirements, however they are attributed to reduced edge sharpness. Intermediate kernels balance detail and noise and are generally suitable for general-purpose imaging. In this regard, different body parts (e.g., lungs, brain, abdomen) and tissues require tailored kernels to optimize diagnostic accuracy. The choice of kernel depends on the clinical indication and the balance required between image detail and noise.

In FBP, the kernel modifies the Fourier transform of the projection data. A commonly used kernel is the Ram-Lak filter, which emphasizes high-frequency components. The kernel is applied via convolution or multiplication in the Fourier domain to the sinogram data. In DL-CT image reconstruction (e.g., from the sinogram domain to the image domain using reconstruction model 108 or the like) kernels are utilized in various ways to enhance the reconstruction process, often acting as tools for feature extraction, noise suppression, or regularization.

While the DFOV is decided by the portion of anatomy to be displayed, the kernel is chosen by the type of anatomy or the type of anatomical structures and the clinical application. DFOV affects pixel resolution (along with finite system bandwidth) for each clinical application. However, for a given modality, training different resolution enhancement models corresponding to resolution enhancement model 112 for different clinical applications (e.g., different types of medical images corresponding to different anatomical regions and/or structures) and DFOVs is a tedious and expensive process. Additionally, in a supervised framework, the training process requires training data pairs (low-resolution and high-resolution images) corresponding to each of the configuration characteristics. Similarly, each kernel has different frequency characteristics and noise behavior. Thus, for a given modality, developing, enhancement models corresponding to resolution enhancement model 112 that account for these wide range of variables (e.g., DFOV, resolution, artifacts, noise and kernel shape) for different clinical applications and anatomical regions/structures is quite complex, often leading to multiple models and sub-optimal solutions.

In accordance with various embodiments, as tailored for a specific modality (e.g., CT, MRI, X-ray, ultrasound, etc.), the resolution enhancement model 112 can be used to increase the bandwidth (and thus resolution) of any medical image of that modality, regardless of the anatomical region and/or structures depicted and the clinical application. In some embodiments, the resolution enhancement model 112 can also be configured to control artifacts and noise in the first enhanced image 304, regardless of the anatomical region and/or structures depicted and the clinical application. For example, increasing the resolution of a medical image can result in increasing the amount and/or severity of artifacts and noise. In some embodiments, the resolution enhancement model 112 can be configured (i.e., trained) to increase the resolution of the medical image 302 while decreasing noise and/or artifacts. In other embodiments, that resolution enhancement model 112 can be configured to increase the resolution (i.e., the bandwidth) of the medical image 302 while also ensuring that the amount of noise and artifacts in the first enhanced image 304 relative to the medical image 302 is not increased or increased-up to an acceptable amount (e.g., only slightly increased). In some embodiments, aside from the modality of the input medical image 302 being the same as that of the training images used to train the model, the input medical images 302 can also be constrained to have a DFOV within a defined range relative to the DFOV of the training images used to train the resolution enhancement model 112.

In various embodiments, to facilitate this end, the resolution enhancement model 112 can be trained on training medical images respectively depicting the same or a similar ROI and the same or similar anatomical structures and associated with the same or a similar clinical application. For example, the training images can respectively adhere to the same configuration characteristics with respect to the type of anatomical structures or tissues of interest depicted, the reconstruction kernel applied, the DFOV, the initial and target resolution, and the initial and target noise level. In this regard, in one or more embodiments, the training process used to train the resolution enhancement model 112 comprises a supervised machine learning process with training images corresponding to input training images having an initial resolution (e.g., a low or native resolution) and ground truth targets for the respective training images. In various embodiments, ground truth targets comprise medical images (or more particularly, synthetic medical images generated from natural images, as described below) reconstructed in accordance with a target kernel that results in the ground truth targets having a high, target bandwidth and thus a high resolution. For example, in various embodiments, the target kernel comprises a sharp kernel.

For example, in some embodiments as applied to CT images, to facilitate creating the reconstruction model 112 being capable of increasing the bandwidth and thus resolution of any type of input CT image, the clinical application associated with the training images can comprise bone imaging and the input training images can comprise CT images depicting bone structures. Bone imaging in CT refers to the use of CT scans to obtain detailed images of bones in the body. It is a highly effective imaging technique that provides high-resolution, cross-sectional images, making it a preferred choice for evaluating bone structures, fractures, and various conditions affecting the skeletal system. For CT bone imaging, sharp kernels (high-frequency kernels) are typically preferred. These kernels are designed to enhance the fine details and edges of the bone structures, making them ideal for visualizing cortical bone, trabecular patterns, fractures, and other bone-related abnormalities. Sharp kernels accentuate the edges and textures of bones, making it easier to identify small fractures, erosions, or subtle abnormalities. Sharp kernels also provide improved spatial resolution, allowing for precise evaluation of the intricate details in cortical and trabecular bone

In some embodiments, training data 132 corresponds to the training data (e.g., the CT bone images and their respective ground truth targets) and the training component 122 can perform the training process to generate the trained version of the resolution enhancement model 112 applied at runtime (e.g., in accordance with process 300).

In some embodiments, as applied to CT, MRI, X-ray and other imaging modalities, the training images (e.g., the input training images and the ground truth targets) used can correspond to natural images converted into synthetic, medical images versions of the natural images. A “natural image” refers to a photograph or image that captures a scene from the physical world, like a landscape, a person, or an object in its natural environment, essentially depicting the typical sights we encounter in everyday life, including computer-generated or artificially manipulated images. Natural images are characterized by complex structures, textures, and variations in lighting that reflect the real world's properties and possess a high resolution. In this regard, because the resolution enhancement model 112 is trained to enhance the resolution of the input images beyond that capable of existing medical imaging systems, actual ground truth targets with such high resolution do not exist. To overcome this obstacle, the natural images are converted into synthetic versions using advanced image processing techniques to simulate the signal data that a scanner would capture, then reconstruct that data into a corresponding image for a given modality (e.g., CT, MR, X-ray, ultrasound, etc.) using a linear projection algorithm. For example, in CT this essentially corresponds to “mapping” the intensity values of the natural image to represent different tissue densities as seen in a CT scan. In another example, for MRI, this corresponds to mapping k-space data generated from the natural images into the image domain.

In accordance with various embodiments, the natural images are converted to synthetic versions in accordance with defined input and target spectral responses such that the resulting ground truth target images have a higher bandwidth than the input training images. In some embodiments, the input training images are degraded by adding noise and artifacts. The degraded input images and the ground truth target images are used to train the resolution enhancement model 112 such that the model learns to improve the resolution of the input while controlling noise and artifacts to be within a defined acceptable range of noise and/or artifacts.

In accordance with conventional supervised machine learning, the training process involves training the resolution enhancement model 112 to increase the bandwidth of the input images to match the bandwidth of the corresponding ground truth targets, adjusting the neural network model parameters (e.g., weights, biases, etc.) to minimize the error (e.g., using any suitable loss function such as mean square error (MSE), mean absolute error (MAE), perception loss, texture loss, or another loss function) between predicted and actual outputs. In addition, in embodiments in which artifacts and noise are injected into the input training images, the resolution enhancement model 112 also learns to modify the amount and severity of the artifacts and noise in the input images relative to the output images as a function of the corresponding controlled amount and severity of noise and artifacts depicted in the ground truth targets, adjusting the neural network model parameters (e.g., weights, biases, etc.) to minimize the error (e.g., using any suitable loss function such as mean square error (MSE), perception loss, texture loss, or another loss function) between the predicted output images and ground truth targets. These adjustments are made through a process called backpropagation combined with an optimization algorithm like stochastic gradient descent (SGD) or its variants. The result of the training process (e.g., via training component 122) is a trained version of the resolution enhancement model 110 configured to receive a medical image (e.g., medical image 302) as input and transform the medical image into an enhanced version thereof (e.g., first enhanced image 304) having increased bandwidth (and thus resolution) while also havening a reduced or controlled amount or severity of artifacts and noise.

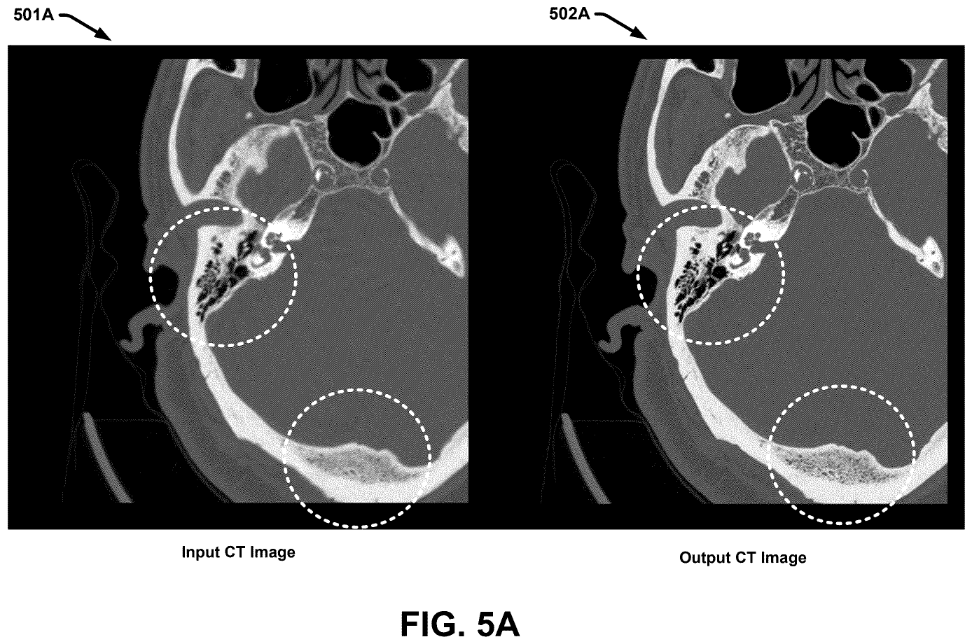

For example, FIGS. 5A and 5B respectively present different examples of input and output CT images of a trained version of the resolution enhancement model 110 in accordance with one or more embodiments. FIG. 5A compares the enhancement of an input CT image 501A in a bone window (WW=1500, WL=300) relative to output CT image 502A by the resolution enhancement model 112. In this regard, input CT image 501A corresponds to an example of medical image 302, and output CT image 502A corresponds to an example of the enhanced version of medical image 302 (e.g., first enhanced medical image 304) generated by the resolution enhancement model 112. As can be seen by comparison of the input CT image 501A and the output CT image 502A in the regions indicated by the dashed circles, the cortical and fine bone structures are sharper in the output CT image 502A and the cancellous bone (spongy bone) appear much clearer relative to the input CT image 501A.

FIG. 5B compares the enhancement of an input CT image 501B in a soft tissue window (Window Level=60, Window Width 400) relative to output CT image 502B by the resolution enhancement model 112. In this regard, input CT image 501B corresponds to another example of medical image 302, and output CT image 502B corresponds to another example of the enhanced version of medical image 302 (e.g., first enhanced medical image 304) generated by the resolution enhancement model 112. In this regard, input CT image 501B differs from input CT image 501A with respect to the DFOV of the input image. In this example, the DFOV of input image 501B is within (e.g., less than) the DFOV of input image 501A, demonstrating that the resolution enhancement model 112 can be applied to different input images with varying DFOVs yet still produce an enhanced output image. As illustrated in FIG. 5B, we can observe that the input CT image 501B has severe artifacts called “pinwheel artifacts (also called as windmill artifacts) which occur due to insufficient sampling in Z-direction during helical acquisitions. These artifacts reduce the image quality as they spread across the image. These artifacts are significantly reduced in the output CT image 502B. We can also observe that the amount of noise is only slightly increased (e.g., controlled noise) in the output CT image 502B compared to the input CT image 501B. In this regard, FIGS. 5A and 5B demonstrate that the resolution enhancement model 112 not only improves the resolution but also controls noise and artifacts.

In some embodiments, the resolution enhancement model 112 is trained using the modulation transfer functions (MTFs) of the respective input images and their corresponding ground truth targets in accordance with their respective reconstruction kernels (e.g., initial and target kernels). The Modulation Transfer Function (MTF) is a fundamental measure of the spatial resolution of an imaging system. It quantifies how well the system can reproduce varying levels of detail (spatial frequencies) from the object being scanned to the final image.

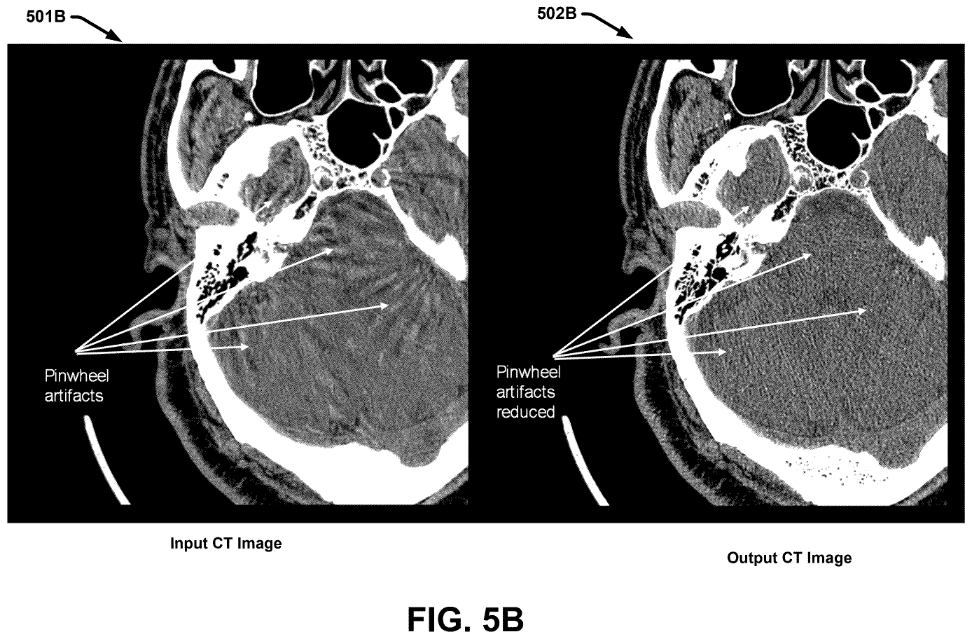

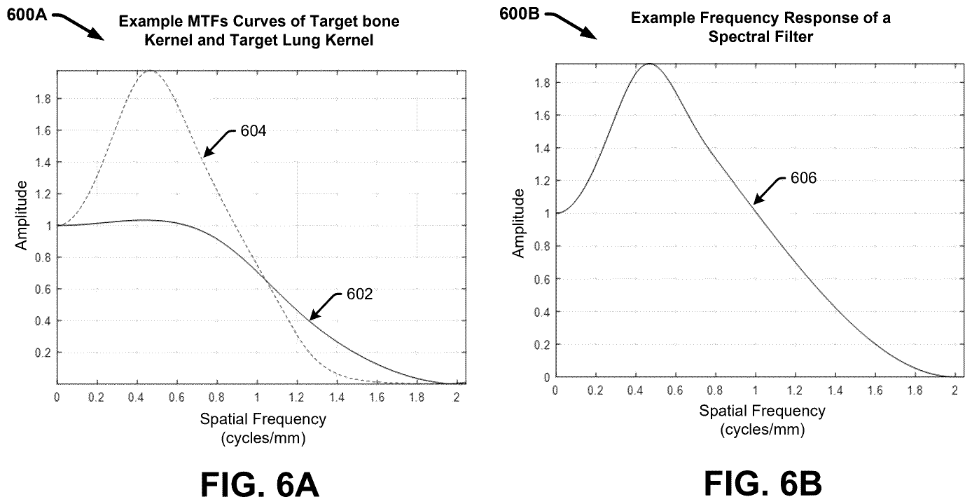

With reference briefly to FIG. 6A, FIG. 6A presents graph 600A comparing the modulation transfer functions (MTFs) of different CT kernels in accordance with one or more embodiments described herein. Different reconstruction kernels can be represented using their MTFs or MTF curves as shown in graph 600A. When referring to a kernel, it's MTF represents a measure of how well that kernel preserves fine details (contrast) in an image across different spatial frequencies, essentially indicating the level of sharpness and resolution achievable with that specific reconstruction kernel used for the CT image. The MTFs curves shown in graph 600A respectively include MTF curve 602, which represents a target bone kernel, and MTF 604 curve, which represents a target lung kernel. These MTF curves plot the how the spectral content is varied at different spatial frequencies, allowing comparison of how well different kernels can reproduce fine details in an image. The x-axis represents the spatial frequency, measured in cycles per millimeter (mm) and the y-axis represents the modulation, measured as a function of amplitude. As the spatial frequency increases on the x-axis, it represents progressively finer details in the image. The y-axis shows the amount of contrast transferred from the object to the reconstructed image at each spatial frequency. Different kernels will produce different MTF curves, reflecting their varying spatial resolution characteristics. By comparing MTF plots of different reconstruction kernels, radiologists can choose the kernel that best balances image sharpness (high spatial frequency response) with noise reduction (smoothness) for a particular clinical situation.

With reference back to training of the resolution enhancement model 112, in various embodiments, the resolution enhancement model is trained to increase the bandwidth of the input training images such that their resulting MTFs correspond to the MTFs of a target kernel used to generate the corresponding ground truth images. For example, as noted above, in some implementations, the ground truth images can include or correspond to synthetic versions of natural images generated via using a target kernel, such as a target bone kernel corresponding to MTF curve 602. The result of the training process is a trained version of the resolution enhancement model 112 configured to receive a medical image 302 as input and output an enhanced version of the medical image (e.g., first enhanced image 304) with an increased bandwidth or spatial resolution that adheres to the target bone kernel MTF curve shape, such as MTF curve 604. In addition, in embodiments, in which artifacts are added to the input training images, the resolution enhancement model 112 also learns how to reduce artifacts in the output images. With these embodiments, the first enhanced image 304 will have reduced artifacts relative to medical image 302. Further, in embodiments, in which noise is added to the input training images, the resolution enhancement model 112 also learns how to reduce or control the amount and/or intensity of the noise in the output images. With these embodiments, the first enhanced image 304 will have a reduced or controlled amount of noise relative to medical image 302.

In accordance with the disclosed techniques, the resolution enhancement component 110 can apply the trained version of the resolution enhancement model 112 to any new medical image (e.g., medical image 302) of the modality in which the resolution enhancement model 112 was trained, regardless of the clinical application (e.g., bone imaging, cardiac imaging, lung imaging, etc.) and/or the type or types of anatomical structures depicted in the new medical image to increase the bandwidth of the image to an enhanced version of the input image with an increased the bandwidth or spatial resolution that adheres to the target kernel MTF curve shape for the clinical application used for the ground truth training images (e.g., MTF curve 602). Additionally, or alternatively, for a given modality, the resolution enhancement component 110 can apply the trained version of the resolution enhancement model 112 to any new medical image of that modality to generate an enhanced version thereof (e.g., first enhanced image 304) so long as the DFOV of the new medical image is within the range of the DFOV of training images used to train the resolution enhancement model 112. As noted above, in preferred embodiments, the target spectral filter or kernel used for the ground truth targets can include or correspond to a sharp kernel (e.g., a bone kernel or another sharp kernel) and the input training images can include added noise and artifacts such that the trained version of the resolution enhancement model 112 learns to control noise and artifacts in the first enhanced images within acceptable amounts while also enhancing the bandwidth/resolution, regardless of the clinical application and anatomical structures depicted in the input images.

The spectral shaping component 114 can further apply a spectral shaping filter (of amongst spectral shaping filters 116₁₋ₖ for example) to the output image of the resolution enhancement model 112 (e.g., the first enhanced image 304) that further refines the output to tailor the resolution, contrast and/or noise properties of the output image based on the clinical application and/or the anatomical structures depicted in the medical image. In other words, spectral shaping component 114 applies a spectral shaping filter (of amongst spectral shaping filters 116₁₋ₖ for example) to the first enhanced image 304 to transform the first enhanced medical image into a second enhanced image 306 having one or more modified properties relative to the first enhanced medical image, wherein the spectral shaping filter is tailored to the anatomical structures depicted in the medical image 302 and/or the clinical application for the medical image 302.

The one or more modified properties include a modification to the frequency content of the first enhanced medical image 304. The frequency content of a medical image refers to the distribution and characteristics of the spatial frequency components that make up the image. In simpler terms, it describes how the details (structures, edges, or textures) in the image are represented in terms of their spatial variations. For example, low frequencies represent smooth variations or large-scale structures in the image (e.g., background intensity or gradual changes). High frequencies represent rapid variations or small-scale structures, such as edges, fine details, and noise. The frequency content of a medical image can be analyzed using a Fourier Transform, which decomposes the image into a sum of sinusoidal patterns of different frequencies and orientation. The result is a frequency domain representation of the image, where the center corresponds to low frequencies and the outer regions correspond to high frequencies.

In this regard, in various embodiments, the spectral shaping filters 116₁₋ₖ can include different, predefined spectral shaping filters tailored to different clinical applications, anatomical ROIs, and/or anatomical structures or tissues of interest. For example, spectral shaping filters 116₁₋ₖ can include a filter tailored to lung imaging (e.g., applied to the first enhanced lung CT image 404), another filter tailored to cardiac imaging, another filter tailored to neuro imaging, and so on. The spectral shaping filters can also include different tailored to different sub-clinical applications or different structures of a particular type of anatomical structures. For example, the spectral shaping filters can include different bone filters tailored for different sub-types of bone imaging applications (e.g., different bones, different types of fractures, etc.). The spectral shaping filters 116₁₋ₖ can also include adaptable filters that can be tailored by manual input and/or manually defined for desired output properties using a spectral shaping application 120. For example, the spectral shaping application 120 can include or correspond to an interactive application via which a user can manually adjust the spectral shaping filter to change the bandwidth and/or change the shape and thus its resulting impact on noise, contrast and resolution in different tissues of the output image as desired. Additionally, or alternatively, the spectral shaping component 114 can employ machine learning and/or artificial intelligence techniques (e.g., deep-learning techniques) to learn and define different optimal spectral shaping filters (e.g., of amongst spectral shaping filters 116₁₋ₖ) tailored to different clinical applications and/or anatomical structures and/or ROIs.

Generally, the spectral shaping filters 116₁₋ₖ change the shape of the MTF curve of the reconstruction kernel applied to the first enhanced CT image 304 to transform the first enhanced CT image 304 into second enhanced CT image 306 that adheres to a different, target MTF curve. For example, with reference again to FIG. 6A, graph 600A plots the MTF curves of a target bone kernel (MTF curve 602) and a target lung kernel (MTF 604 curve). In various embodiments, the target bone kernel MTF curve in graph 600A corresponds to the target bone kernel used to train the enhancement model 112. As can be seen by comparison of the target bone kernel MTF curve 602 relative to the target lung kernel MTF curve 604, the target bone kernel MTF curve 602 has a different shape. More particularly, the target bone kernel MTF curve 602 provides an increased bandwidth or spatial frequency relative to the target lung kernel MTF curve 604. The target bone kernel MTF curve 602 further demonstrates a significantly lower and steady amplitude across the mid-spatial frequency region (e.g., between about 0.2 to about 0.6 cycles/mm) relative to the target lung kernel MTF curve 604. In this regard, in embodiments in which the resolution enhancement model 112 is trained on bone kernel data, regardless of the anatomical region depicted in an input CT image processed by the trained version of the model, the output image, that is the first enhanced CT image 304, will have an increased bandwidth that adheres to that of the target bone kernel MTF curve 602.

In various embodiments, the respective spectral shaping filters 116₁₋ₖ can be configured to modify one or more properties of the frequency content of the first enhanced CT image 304 in a manner that modifies the kernel shape of the first enhanced CT image 304 to be more in line with that of a target kernel for the anatomical region or structure depicted. In other words, adapting the kernel shape from a bone kernel to a lung kernel, or another anatomical kernel shape. In some implementations, the one or more modified properties can include an amplitude change to a spectral frequency region within the increased bandwidth of the first enhanced CT image 304, and wherein the change and the frequency region are tailored to the anatomical region or structure represented in the CT image 302. Additionally, or alternatively, the one or more modified properties can include a bandwidth change to a spectral frequency content of the first enhanced CT image 304, and wherein the bandwidth change is tailored to the anatomical region or structure represented in the CT image 302. As visualized via an MTF curve, this corresponds to changing the shape of the MTF curve of the kernel employed to generate the first enhanced CT image 304, such as changing the bone MTF curve 602 to more resemble an MTF curve for the anatomical region or structure represented in the CT image 302, and applying the modified kernel to the first enhanced CT image 304 to transform it into the second enhanced CT image 306.

In various embodiments, the spectral shaping filters 116₁₋ₖ can be configured to modify the bone kernel MTF curve 602, which is that resulting for the first enhanced CT image 304 (e.g., in embodiments where the enhancement model 112 is trained on target bone kernel data), to a target kernel MTF for the anatomical region depicted in the CT image. For example, as applied to lung CT images, in some embodiments, the spectral shaping filter used can be configured to transform the first enhanced lung CT image 404 into the second enhanced lung CT image 406 in accordance with the target lung kernel MTF curve 604, which has similar bandwidth as the target bone kernel MTF curve 602 while also having a heavily boosted mid-frequency region in line with the target bone kernel. In another embodiment as applied to lung CT images, the spectral shaping filter used can be configured to transform the first enhanced lung CT image 404 into the second enhance lung CT image 406 in accordance with an optimized lung kernel MTF curve which combines aspects of MTF curve 602 and MTF curve 604.

In this regard, FIG. 6B presents graph 600B showing a harmonizing spectral filter 606 which combines aspects of MTF curve 602 and MTF curve 604. The spectral filter 606 is designed such that when it applied on MTF curve 602 it will result in MTF Curve 604. In this regard, the spectral shaping filter (of amongst spectral shaping filters 116₁₋ₖ) applied for a lung CT image can be configured to heavily increase the mid-frequency region of the Fourier spectrum of the first enhanced image 304 such that the second enhanced image 306 comprises enhanced contrast in lung parenchyma relative to first enhanced image 304, as shown in FIG. 4 with respect to first enhanced lung CT image 404 and second enhanced lung CT image 406.

In another example in which the CT image 302 corresponds to a bone imaging CT image depicting one or more bone structures of interest, the spectral shaping filter (of amongst spectral shaping filters 116₁₋ₖ) applied can be configured to slightly increase the mid-frequency region of the target bone kernel filter within the mid-frequency region within the increased bandwidth of the first enhanced CT image 304 such that the second enhanced CT image 306 comprises a sharper visual representation of the bone structure relative to the first enhanced CT image 304. In another example, the spectral shaping filter (of amongst spectral shaping filters 116₁₋ₖ) applied for a cardiac CT image (with clinical applications concerning optimization of visual properties of heart tissue), can be configured to heavily to adjust the spectral frequency amplitude at target regions and/or adjust the bandwidth such that the second enhanced CT image 306 ensures noise is well controlled while maintaining sufficient resolution to visualize plaques, stents, and smaller vessels.

In this summary, in accordance with various embodiments, the resolution enhancement component 110 employs the resolution enhancement model 112 to transform a medical image (e.g., medical image 302) into a first enhanced medical image (e.g., first enhanced image 304) having an increased bandwidth with a controlled or reduced amount and/or severity of artifacts and noise relative to the medical image and/or with modified noise characteristics relative to the medical image, wherein the resolution enhancement model 112 is configured to generate the first enhanced medical image regardless of anatomical structures depicted in the medical image and/or a clinical application for the medical image. The spectral shaping component 114 further applies a spectral shaping filter (e.g., of amongst spectral shaping filters 116₁₋ₖ) to the first enhanced medical image to transform the first enhanced medical image into a second enhanced medical image (e.g., second enhanced image 306) having one or more modified properties relative to the first enhanced medical image, wherein the spectral shaping filter is tailored to the anatomical structures and the clinical application.

To facilitate this end, the spectral shaping component 114 can first transform the first enhanced image 304 into the frequency domain using a linear transformation tailored to the modality of the medical image 302 (e.g., a Fourier transform for CT and MRI) and then applies the spectral shaping filter to the frequency domain representation of the medical image to generate an enhanced frequency domain representation. The spectral shaping component 114 then applies the reverse linear transformation to convert the enhanced frequency domain representation back to the image domain.

In some implementations, the one or more modified properties comprise a change to frequency content of the first enhanced medical image within the increased bandwidth, wherein the change is tailored to the anatomical structures and the clinical application. Additionally, or alternatively, the one or more modified properties comprise a change to the increased bandwidth, wherein the change is tailored to the anatomical structures and the clinical application.

In various embodiments, based on the anatomical structures or the clinical application comprising a first type of anatomical structures or a first clinical application, the one or more modified properties comprise a first change to frequency content of the first enhanced medical image, and wherein based on the anatomical structures and the clinical application comprising a second type of anatomical structures or a second clinical application different from the first clinical application, the one or more modified properties comprise a second change to frequency content of the first enhanced medical image different from the first change.

In various embodiments, the resolution enhancement model 112 transforms the medical image into the first enhanced medical image in accordance with a first kernel tailored to a first type of anatomical structures and a first clinical application, and wherein the spectral shaping filter corresponds to a second kernel different from the first kernel. In some implementations of these embodiments, based on the anatomical structures and the clinical application corresponding to the first type and the first clinical application respectively, the second kernel corresponds to a modified version of the first kernel. In other implementations of these embodiments, based on the anatomical structures or the clinical application corresponding to a second type of anatomical structures or a second clinical application different from the first clinical application respectively, the second kernel is tailored to the second type of anatomical structures and/or the second clinical application. Still in other implementations, based on the anatomical structures or the clinical application corresponding to a second type of anatomical structures or a second clinical application different from the first clinical application respectively, the second kernel (e.g., corresponding to MTF curve MTF curve 604) corresponds to a harmonized or combined version of the first kernel (e.g., corresponding to MTF curve 602) with a third kernel (e.g., corresponding to spectral filter 606), tailored to the second type of anatomical structures and/or the second clinical application.

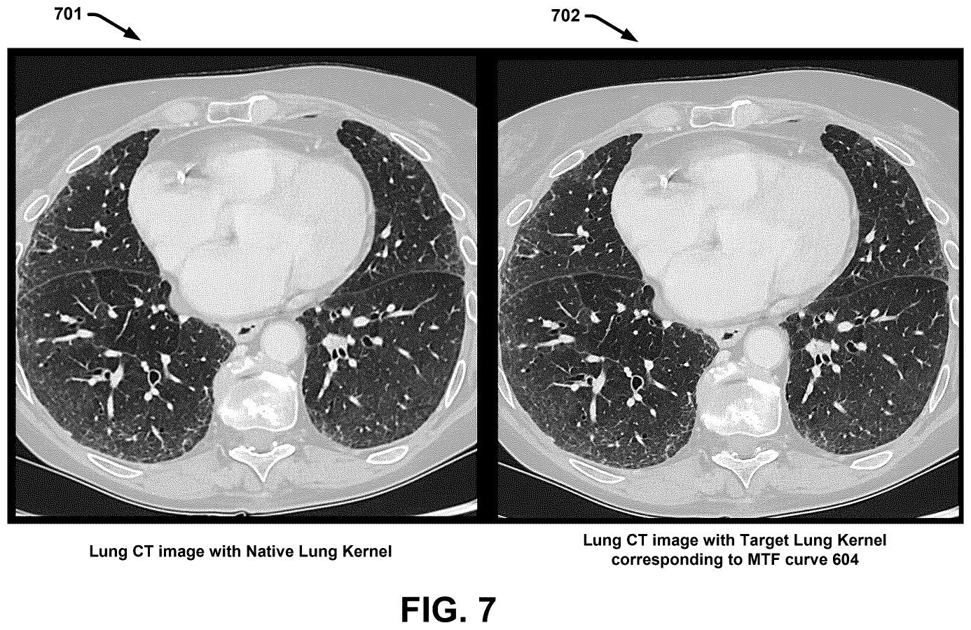

FIG. 7 illustrates example versions of CT images in accordance with one or more embodiments described herein. FIG. 7 presents two lung CT images, including CT image 701 and CT image 702. CT image 701 corresponds lung CT image reconstructed by native/traditional lung reconstruction kernel and CT image 702 corresponds to second enhanced lung CT image having a target lung kernel MTF curve corresponding to MTF curve 604, that was filtered from a first enhanced lung CT image (e.g., first enhanced lung CT image 406) using a spectral shaping filter (corresponding to curve 606) of amongst spectral shaping filters 116₁₋ₖ having a target lung kernel MTF curve corresponding to MTF curve 606. As can be seen by comparison of lung CT image by the native lung kernel in the CT system 701, to the lung CT image 702 with target lung kernel corresponding to MTF curve 604, the lung CT image with target lung kernel 702 has superior image quality in terms of resolution and contrast in the lung parenchyma compared to lung CT image with native lung kernel 701.

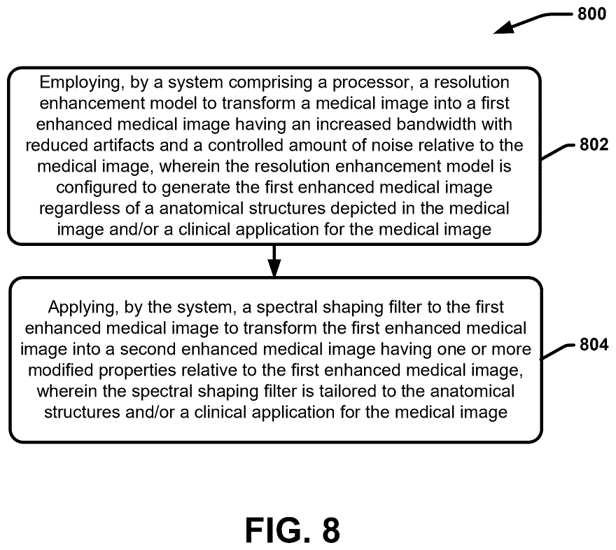

FIG. 8 illustrates an example computer-implemented method 800 for enhancing medical images, in accordance with one or more embodiments described herein. Method 800 comprises, at 802, employing, by a system comprising a processor (e.g., system 100), a resolution enhancement model (e.g., resolution enhancement model 112) to transform a medical image into a first enhanced medical image having an increased bandwidth with reduced artifacts and a controlled amount of noise (e.g., a reduced amount of noise, a same amount of noise, or a slightly increased amount of noise as controlled to be a within a threshold amount or percentage of increase) relative to the medical image, wherein the resolution enhancement model is configured to generate the first enhanced image data regardless of anatomical structures (or more particularly the type of anatomical structures (depicted in the medical image) and/or a clinical application for the medical image. At 804, method 800 comprises applying, by the system (e.g., via spectral shaping component 114), a spectral shaping filter to the first enhanced medical image to transform the first enhanced medical image into a second enhanced CT image having one or more modified properties relative to the first enhanced medical image, wherein the spectral shaping filter is tailored to the anatomical structures and/or the clinical application for the medical image.

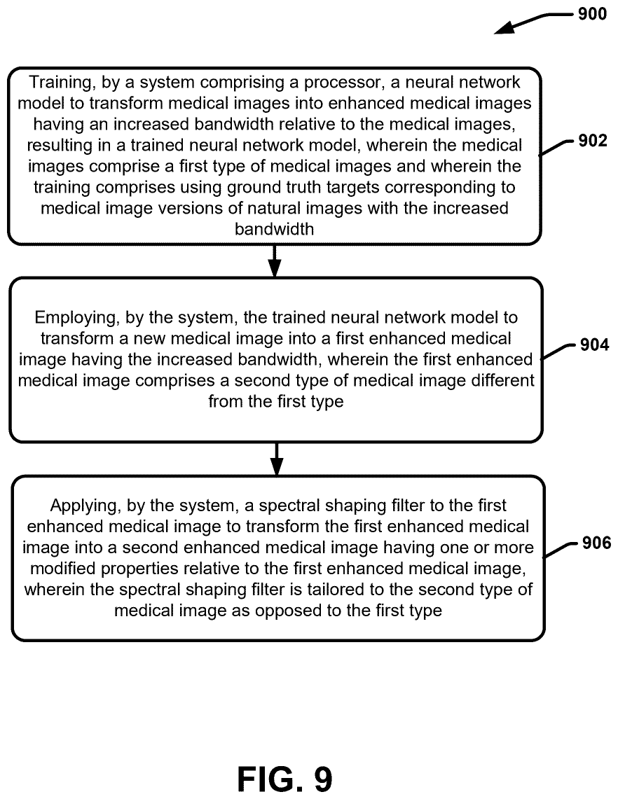

FIG. 9 illustrates another example computer-implemented method 900 for enhancing medical images, in accordance with one or more embodiments described herein. Method 900 comprises, at 902, training, by a system comprising a processor (e.g., system 100), a neural network model (e.g., resolution enhancement model 112) to transform medical images into enhanced medical images having an increased bandwidth relative to the medical images, resulting in a trained neural network model, wherein the medical images comprise a first type of medical images and wherein the training comprises using ground truth targets corresponding to medical image versions of natural images with the increased bandwidth. At 904, method 900 comprises employing, by the system, the trained neural network model to transform a new medical image into a first enhanced medical image having the increased bandwidth, wherein the new medical image comprises a second type of image different from the first type (yet having the same modality). For example, in various embodiments, the first type comprises a bone CT image (or a synthetic, medical image version of a natural image generated using a bone CT kernel) and the second type comprises a lung CT image, a cardiac CT image, a neuro CT image or another type of CT image data different from the bone CT image yet having a DFOV within the range of the DFOV of the bone CT image type. At 906, method 900 further comprises applying, by the system, a spectral shaping filter to the first enhanced medical image to transform the first enhanced medical image into a second enhanced medical image data having one or more modified properties relative to the first enhanced medical image, wherein the spectral shaping filter is tailored to the second type of medical image as opposed to the first type.

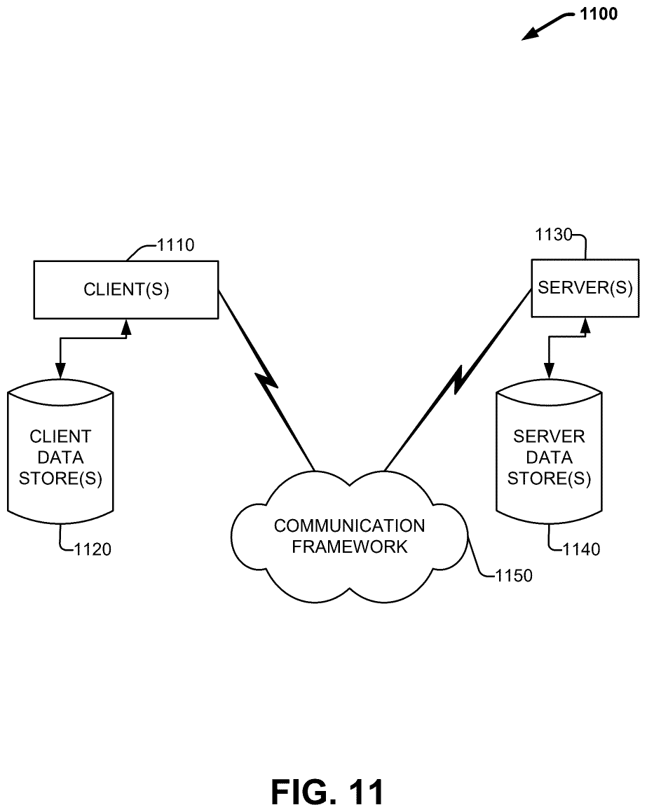

In order to provide a context for the various aspects of the disclosed subject matter, FIGS. 10 and 11 as well as the following discussion are intended to provide a brief, general description of a suitable environment in which the various aspects of the disclosed subject matter may be implemented.

With reference to FIG. 10, a suitable environment 1000 for implementing various aspects of this disclosure includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13104), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 also includes removable/non-removable, volatile/non-volatile computer storage media. FIG. 10 illustrates, for example, a disk storage 1024. Disk storage 1024 includes, but is not limited to, devices like a magnetic disk drive, floppy disk drive, tape drive, Jaz drive, Zip drive, LS drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used, such as interface 1026.

FIG. 10 also depicts software that acts as an intermediary between users and the basic computer resources described in the suitable operating environment 1000. Such software includes, for example, an operating system 1028. Operating system 1028, which can be stored on disk storage 1024, acts to control and allocate resources of the computer system 1012. System applications 1030 take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1000 with which the subject matter of this disclosure can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing this disclosure, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1120 that can be employed to store information local to the client(s) 1110. Similarly, the server(s) 1130 are operatively connected to one or more server data store(s) 1140 that can be employed to store information local to the servers 1130.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
at least one memory that stores computer-executable components; and
at least one processor that executes the computer-executable components stored in the at least one memory, wherein the computer-executable components comprise:
a resolution enhancement component that employs a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures depicted in the medical image and a clinical application for the medical image; and
a spectral shaping component that applies a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.

2. The system of claim 1, wherein the one or more modified properties comprise a change to frequency content of the first enhanced medical image within the increased bandwidth, wherein the change is tailored to the anatomical structures and the clinical application.

3. The system of claim 1, wherein the one or more modified properties comprise a change to the increased bandwidth, wherein the change is tailored to the anatomical structures and the clinical application.

4. The system of claim 1, wherein based on the anatomical structures or the clinical application comprising a first type of anatomical structures or a first clinical application, the one or more modified properties comprise a first change to frequency content of the first enhanced medical image, and wherein based on the anatomical structures and the clinical application comprising a second type of anatomical structures or a second clinical application different from the first clinical application, the one or more modified properties comprise a second change to frequency content of the first enhanced medical image different from the first change.

5. The system of claim 1, wherein the resolution enhancement model transforms the medical image into the first enhanced medical image in accordance with a first kernel tailored to a first type of anatomical structures and a first clinical application, and wherein the spectral shaping filter corresponds to a second kernel different from the first kernel.

6. The system of claim 5, wherein based on the anatomical structures and the clinical application corresponding to the first type and the first clinical application respectively, the second kernel corresponds to a modified version of the first kernel.

7. The system of claim 5, wherein based on the anatomical structures or the clinical application corresponding to a second type of anatomical structures or a second clinical application different from the first clinical application respectively, the second kernel is tailored to the second type of anatomical structures and/or the second clinical application.

8. The system of claim 5, wherein based on the anatomical structures or the clinical application corresponding to a second type of anatomical structures or a second clinical application different from the first clinical application respectively, the second kernel corresponds to a modified version of the first kernel with a third kernel tailored to the second type of anatomical structures and/or the second clinical application.

9. The system of claim 1, wherein the resolution enhancement model comprises a neural network model, and wherein the computer-executable components further comprise:
a training component that trains the neural network model on training images corresponding to a first clinical application and using a supervised machine learning process with ground truth targets corresponding to medical image versions of natural images reconstructed in accordance with a target kernel for the first clinical application.

10. The system of claim 9, wherein the training images comprise input training images with added noise and artifacts.

11. The system of claim 9, wherein the anatomical structures comprise a second type of anatomical structures and the clinical application for the medical image comprises a second clinical application different from the first clinical application, and wherein the medical image comprises an image reconstructed in accordance with a different kernel relative to the target kernel, the different kernel being tailored to the second type of anatomical structures and the second clinical application.

12. The system of claim 10, wherein the first type of anatomical structures comprises bones and the first clinical application comprises a bone imaging application and wherein the target kernel comprises a sharp kernel.

13. The system of claim 1, wherein the medical image comprises a computed tomography image.

14. A method, comprising:
employing, by a system comprising a processor, a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures depicted in the medical image and a clinical application for the medical image; and
applying, by the system, a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.

15. The method of claim 14, wherein the one or more modified properties comprise at least one of, a first change to frequency content of the first enhanced medical image within the increased bandwidth, wherein the first change is tailored to the anatomical structures and the clinical application, or a second change to the increased bandwidth, wherein the second change is tailored to the anatomical structures and the clinical application.

16. The method of claim 14, wherein based on the anatomical structures comprising a first type of anatomical structures and the clinical application comprising a first clinical application, the one or more modified properties comprise a first change to frequency content of the first enhanced medical image, and wherein based on the anatomical structures comprising a second type of anatomical structures and clinical application comprising a second clinical application different from the first clinical application, the one or more modified properties comprise a second change to frequency content of the first enhanced medical image different from the first change.

17. The method of claim 14, wherein the resolution enhancement model transforms the medical image into the first enhanced medical image in accordance with a first kernel tailored to a first type of anatomical structures and a first clinical application, and wherein the spectral shaping filter corresponds to a second kernel different from the first kernel.

18. The method of claim 17, wherein based on the anatomical structures comprising a first type of anatomical structures and the clinical application comprising a first clinical application, the second kernel corresponds to a modified version of the first kernel, and wherein based on the anatomical structures comprising a second type of anatomical structures and the clinical application comprising a second clinical application, the second kernel is tailored to the second type of anatomical structures and the second clinical application.

19. The method of claim 14, wherein the resolution enhancement model comprises a neural network model, and wherein the method further comprises:
training, by the system, the neural network model on training images associated with a first clinical application and using a supervised machine learning process with ground truth targets corresponding to medical image versions of natural images reconstructed in accordance with a target kernel for the first clinical application, wherein the anatomical structures comprise a second type of anatomical structures and the clinical application for the medical image comprises a second clinical application, and wherein the medical image comprises an image reconstructed in accordance with a different kernel relative to the target kernel, the different kernel being tailored to the second type and the second clinical application.

20. A non-transitory machine-readable storage medium, comprising executable instructions that, when executed by a processor, facilitate performance of operations, comprising:
employing a resolution enhancement model to transform a medical image into a first enhanced medical image having an increased bandwidth with reduced artifacts and a controlled amount of noise relative to the medical image, wherein the resolution enhancement model is configured to generate the first enhanced medical image regardless of anatomical structures depicted in the medical image and a clinical application for the medical image; and
applying a spectral shaping filter to the first enhanced medical image to transform the first enhanced medical image into a second enhanced medical image having one or more modified properties relative to the first enhanced medical image, wherein the spectral shaping filter is tailored to the anatomical structures and the clinical application.
